(19) United States
(12) Patent Application Publication
(10) Pub. No.: US 2009/0032199 A1
(43) Pub. Date: Feb. 5, 2009

(54) Decorative and protective covering for the vanes and valances of blind systems

(76) Inventor: Gloria Woods, Riverside, CA (US)

Correspondence Address: LAW OFFICES OF ANDREW SCHROEDER, P.O. Box 6731, Santa Maria, CA, 93454, US

(21) Appl. No.: 11/888,223

(22) Filed: Jul. 30, 2007

(51) Int. Cl. E06B 9/26

(52) U.S. Cl. 160/34

(57) ABSTRACT

A covering for vanes and valances of a window treatment comprising a covering for a vane and a covering for a valance. The elongate cover is sized to enclose a vane of a blind system. The vane cover comprises a first distal end, a second distal end, a first surface, a second surface, a third surface, and a fourth surface. The first and second surfaces are affixed to the third and fourth surfaces at a seam axis. The elongate envelope is comprised of a left end, a right end, a first side, a second side, a third side, and a fourth side. The valance is disposed within the elongate envelope.

### FIELD OF THE INVENTION

The present invention relates with window treatments such as vertical blinds.

### BACKGROUND OF THE INVENTION

Window treatments such as vertical blind systems are an integral part of any dwelling, home, office building, or any structure with windows. It is not widely known that vertical blind systems contribute a large part to energy expenditures and emissions each year. In the United States, some experts estimate that over 50% of all energy resources are used for the heating, ventilating, and air conditioning of homes and buildings. And a large part of these energy expenditures can be decreased with appropriate window treatments such as vertical blind systems.

One of the main conduits of heat loss or heat gain of any home are the windows. Thermodynamically, glass is a poor insulator of heat and as a result, window treatments become important for reducing utility costs. By using vertical blinds, horizontal blinds, or curtains a user can greatly decrease the amount of heat gain and heat loss in a home or building. Through the use of vertical blinds in an apartment, a user may cut his or her heating and air conditioning bills by over $100 per year.

Given the importance of vertical blinds in apartments and homes it would be desirable for a user to be able to possess the options for coordinating the color schemes between the vertical blinds and the carpet, furniture, rugs, etc. This would enable a user to truly make their dwelling their own home. Unfortunately, apartment owners simply do not have the ability to reasonably color-coordinate their vertical blinds due to the lack of colors, styles, designs, motifs, etc. for the purpose of interior decoration. Moreover, since most apartments are encumbered with restrictive covenants regarding the lessee's ability to paint, wallpaper, etc. the lessee is not able to properly lighten up their dwelling.

Another problem which inheres with many vertical blinds is the fact that UV radiation may wear down the vanes and make them brittle over time. Currently there is no apparatus or means offered in the market-place which enables a user to adequately protect the vanes of a vertical blind system.

Another problem which inheres with the use of vertical blinds is the fact that they are very difficult and cumbersome to clean. Unfortunately, given their material qualities, height, orientation, and suspension with the headrail many owners simply abandon the idea of cleaning their vertical blinds which may carry many allergy-inducing particles such as dust and pollen.

Another problem with most vertical blinds is that when they wear down or become less aesthetically pleasing they are often thrown into landfills rather than recycled. This is problematic because they are not biodegradable and they further exacerbate the dilemma of overflowing landfills.

Therefore, what is clearly needed in the marketplace is an apparatus, system, and means for the purpose of interior decorating through the use of vane coverings. These vane coverings may be seasonal, possess different colors, designs, motifs and styles to coordinate with the carpet, furniture, and rugs of an apartment, home, or office building.

### SUMMARY OF THE INVENTION

It is an object of the present invention to provide a system and apparatus to protect the individual vanes and valances of various window treatments such as vertical blind systems. The covering will shield the vanes and valances from harmful ultraviolet radiation from the sun.

It is an object of the present invention to provide an aesthetically-pleasing system which is customizable for the user. This system enables a user to regularly change the look and feel of the interior design of a home, apartment, office building, and the like. This system can enable a user or manufacturer to provide various colors, depictions, designs, trademark displays, etc.

It is also an object of the present invention to provide a system which is easily washable. The coverings of the vanes or valances may be regularly washed and cleaned in either washing machines or at the dry-cleaners. This unique advantage and feature is particularly useful to users with allergies.

It is a further object of the present invention to provide an environmentally friendly system which encourages users to implement an environmentally-friendly window treatment. By encouraging users to use vertical blinds, vast amounts of energy savings will result.

### BRIEF DESCRIPTION OF THE DRAWING FIGURES

FIG. 1 is a perspective view of a preferred embodiment of the present invention.

FIG. 2 is a perspective view of a preferred embodiment of the present invention.

FIG. 3 is a perspective view of a preferred embodiment of the present invention.

FIG. 4 is a perspective view of a preferred embodiment of the present invention.

FIG. 5 is a perspective view of a preferred embodiment of the present invention.

FIG. 6 is a plan view of a preferred embodiment of the present invention.

FIG. 7 is a plan view of a preferred embodiment of the present invention.

FIG. 8 is a plan view of a preferred embodiment of the present invention.

FIG. 8 is a plan view of a preferred embodiment of the present invention.

FIG. 9 is a plan view of a preferred embodiment of the present invention.

FIG. 10 is a plan view of a preferred embodiment of the present invention.

FIG. 11 is a plan view of a preferred embodiment of the present invention.

FIG. 12 is a plan view of a preferred embodiment of the present invention.

FIG. 13 is a plan view of a preferred embodiment of the present invention.

FIG. 14 is a plan view of a preferred embodiment of the present invention.

FIG. 15 is a plan view of a preferred embodiment of the present invention.

### DESCRIPTION OF PREFERRED EMBODIMENTS

According to a preferred embodiment of the present invention, a unique system, and apparatus is used to protect and aesthetically enhance the vanes and valances of vertical blind systems. The invention is described in enabling detail below.

For the purposes of the present invention the term “vane” shall hereafter refer and describe those individual vertical members which cover the window area for the purpose of shielding the inside area of a structure from sunlight. The term “vane” may also be used interchangeably with the term “blind” or “blinds”.

For the purposes of the present invention the term “valance” shall hereafter refer to the horizontally disposed member with is typically placed in front of the headrail.

For the purposes of the present invention the term “headrail” shall hereafter refer to the device typically disposed above the vanes which comprises those components which enable the system to move the vanes.

For the purposes of the present invention the term “indicia” shall hereafter refer to drawings and other ornamental art or depictions which are disposed on the outer surfaces of the vane covering or the valance covering. The term indicia may also incorporate words such as trademarks, trade-names, etc.

For the purposes of the present invention, the scope of the present invention should not be construed to only cover vertical blind systems. Other window treatments such as venetian blinds, or similar horizontal blind systems may also incorporate the present invention as well.

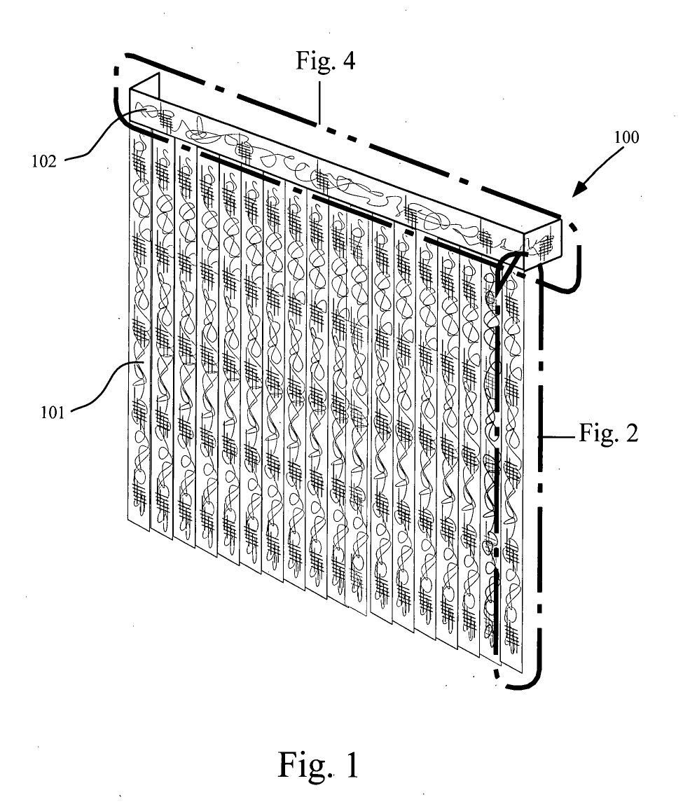

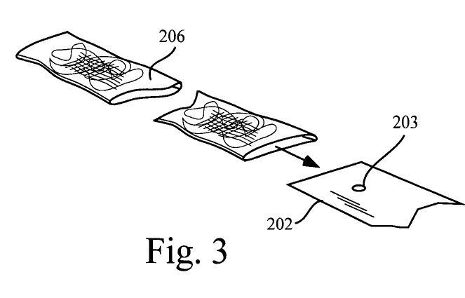

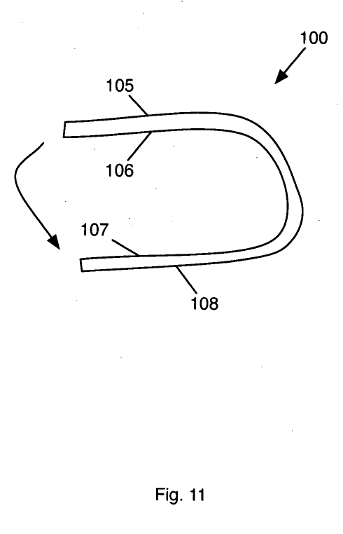

FIG. 1-3 and FIG. 11 illustrates a preferred embodiment of the present invention. A covering 100 for vanes of a blind system includes an elongate cover 101 sized to enclose a vane 202 of a blind system. The elongate cover comprises a first distal end 205, a second distal end 206, a first surface 105, a second surface 106, a third surface 107, and a fourth surface 108. The first and second surfaces are affixed to the third and fourth surfaces at a seam axis 109. In addition, in some preferred embodiments the covering for vanes may further include an orifice 203. The orifice is disposed near the first distal end of the elongate cover.

It should be noted here that in some preferred embodiments the covering for vanes will be open at the second distal end and closed at the first distal end. The term “open” refers to the ability to insert the vane inside the covering from that distal end. The term “closed” refers to the characteristic of the surfaces being conjoined or affixed to each other. The reason that some preferred embodiments are open at the second distal end is to prevent the covering for blinds from falling off the vane.

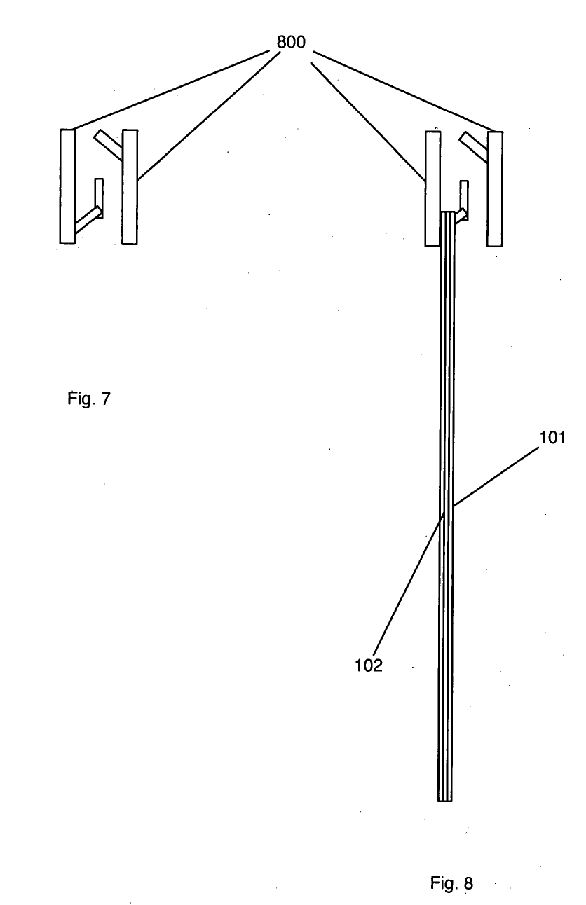

The purpose of the vane orifice is to provide a means for affixing the covering for vanes to the vane and the hook 800 which is affixed with the headrail of the blind system as depicted in FIG. 7 and FIG. 8. The orifice 203 aligns with the vane orifice 204 and is sized to fit the hook.

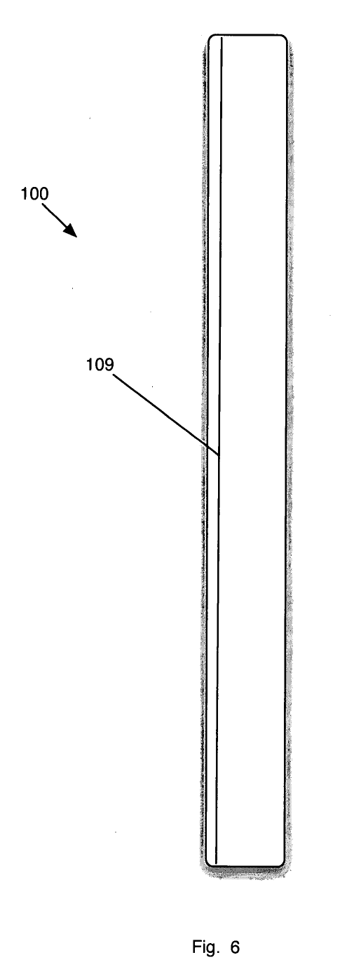

FIG. 6 illustrates a preferred embodiment where the seam orifice demarks the line where the surfaces of the covering are affixed to each other. These surfaces may be joined through means of zippers, buttons, adhesives, removable liners, tape, sewing etc.

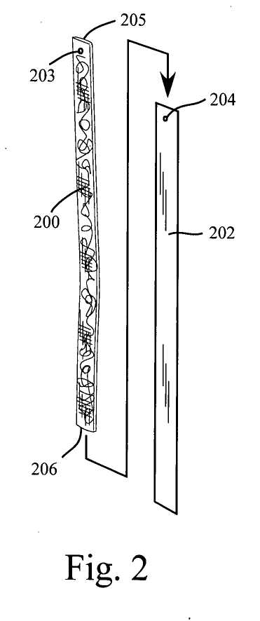

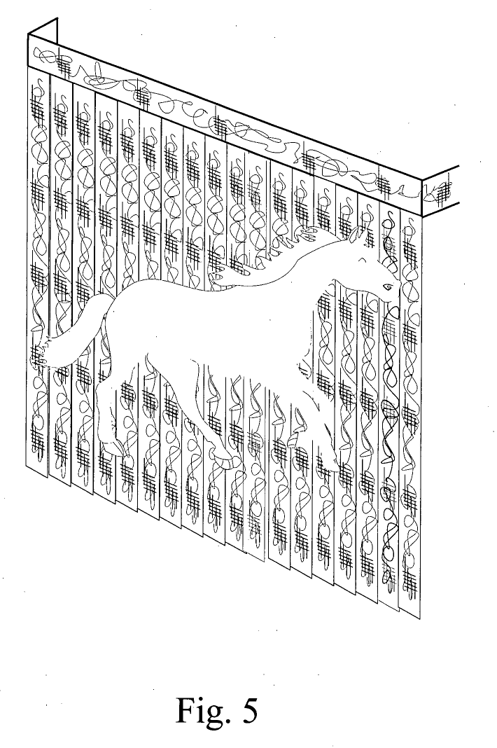

FIG. 2 illustrates that some preferred embodiments of the present invention may further comprise indicia 200. The function of the indicia may be purely ornamental or aesthetic in some preferred embodiments. Moreover, the coverings of the vanes may each comprise a portion of a larger depiction or drawing which may be viewed only by juxtaposing all of the vane coverings side by side in the appropriate order as illustrated in FIG. 5. In addition, the indicia may also be a trademark, trade name, or similar slogans or words. The possibilities are endless.

Moreover, in some preferred embodiments the first and fourth surfaces of the vane coverings may have different colors or different indicia. For this reason, the user may elect to view one color on one particular day and another on another particular day or occasion by simply reversing the side of the vanes through the blind system.

In some preferred embodiments the vane covering may be a fabric. This fabric may be machine-washable in some preferred embodiments. In other preferred embodiments the fabric may be dry-cleanable. The particular fabric to be used with the present invention will be determined in large part to cost, aesthetics, embroidery, the climate or region of use etc.

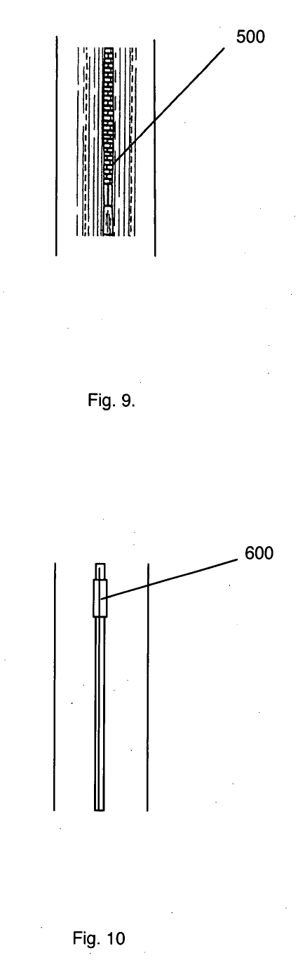

FIGS. 9 and 10 illustrate that in some preferred embodiments the vane coverings may further comprise a zipper. (It should be noted here that in most preferred embodiments sewing will be used for affixing the surfaces together.) The zipper 500 may be made of metal as depicted in FIG. 9. Or, in other preferred embodiments the zipper 600 may be comprised of hollow plastic (or other suitable material) tubes as depicted in FIG. 10.

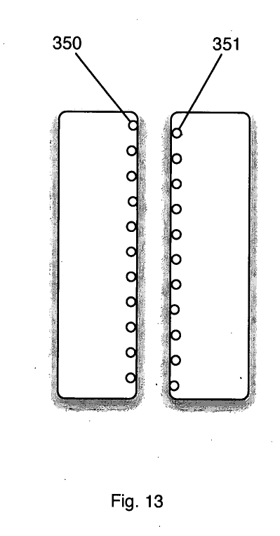

FIG. 13 illustrates a preferred embodiment wherein buttons 350, 351 are used to affix the surfaces of the vane covering together. The mating buttons are sized to fit with each other.

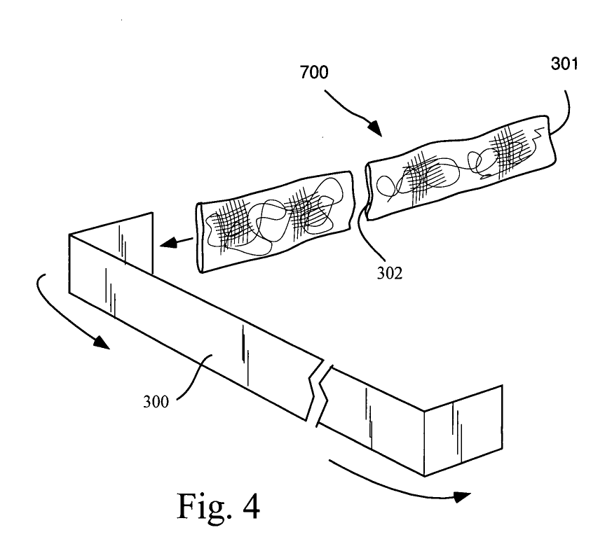

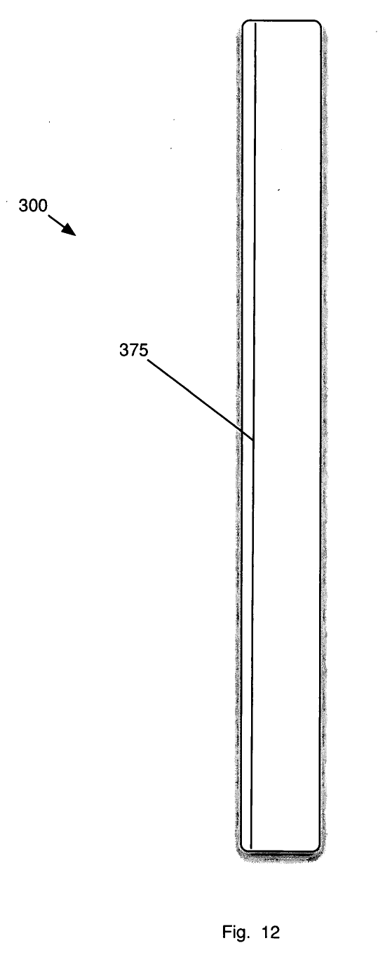

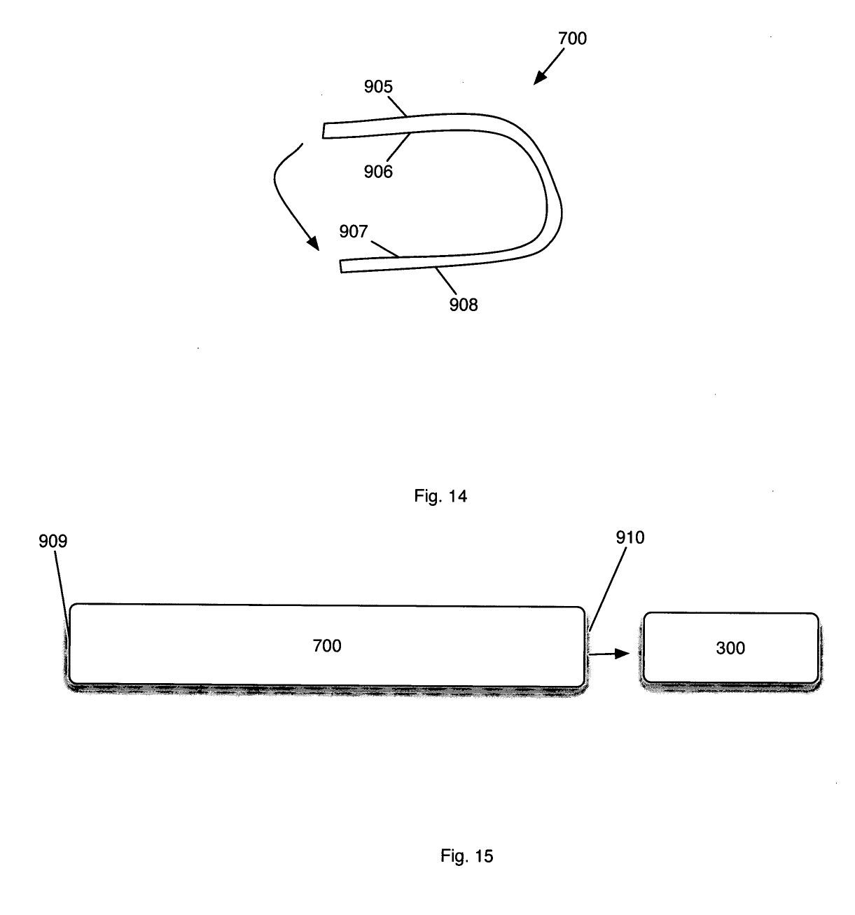

FIGS. 4, 14, and 15 illustrate another preferred embodiment of the present invention. The valance covering 400 is in the shape of an elongate envelope member. The elongate envelope is comprised of a left end 302, a right end 301, a first side 905, a second side 906, a third side 907, and a fourth side 908. The valance 300 is disposed within the elongate envelope. FIG. 12 illustrates that the valance covering also has a valance seam 375 where the second side is affixed with the third side.

The valance covering may be comprised of fabrics which are machine-washable or dry-cleanable in some preferred embodiments. Moreover, the surfaces of the valance covering may be affixed with each other through sewing, buttons, zippers, adhesives, tape, etc.

In some preferred embodiments the valance covering may further include indicia such as ornamental or aesthetic renderings designed to enhance the look of the blind system. In other preferred embodiments the indicia of the valance covering may be comprised of trademarks, trade names, logos, etc. Moreover, it may be desirable in some preferred embodiments that the colors, indicia, etc. of the valance covering match in color, scheme, coordination, motif, style, etc. to achieve a unified and elegant look and feel. The possibilities are endless.

Those skilled in the art will appreciate numerous variations in the present system, configuration and operation that are within the scope of the invention. Those skilled in the art will also appreciate how the principles illustrated in these preferred embodiments can be used in other examples of the invention. A particular reference number in one figure refers to the same element in all of the other figures.

Moreover, It will be apparent to the skilled artisan that there are numerous changes that may be made in embodiments described herein without departing from the spirit and scope of the invention. As such, the invention taught herein by specific examples is limited only by the scope of the claims that follow.

What is claimed is:

1. A covering for vanes of a blind system comprising;
an elongate cover sized to enclose a vane of a blind system;
the elongate cover comprises a first distal end, a second distal end, a first surface, a second surface, a third surface, and a fourth surface;
the first and second surfaces are affixed to the third and fourth surfaces at a seam axis.

2. The covering for vanes of a blind system of claim one further comprising an orifice; the vane orifice is disposed near the first distal end of the elongate cover.

3. The covering for vanes of a blind system of claim 2 wherein the first and second surfaces are affixed to the third and fourth surfaces at the seam axis through sewing.

4. The covering for vanes of a blind system of claim 3 further comprising a plurality of buttons.

5. The covering for vanes of a blind system of claim 4 further comprising indicia.

6. The covering for vanes of a blind system of claim 5 wherein the first surface is coated with a first color and the fourth surface is coated with a second color.

7. The covering for vanes of a blind system of claim 6 wherein the elongate cover is comprised of a fabric.

8. The covering for vanes of a blind system of claim 7 wherein the fabric is machine-washable.

9. The covering for vanes of a blind system of claim 7 wherein the dry-cleanable.

10. The covering for vanes of a blind system of claim 1 further comprising a zipper.

11. The covering for vanes of a blind system of claim 1 further comprising a plurality of mating buttons.

12. A covering for a valance of a blind system; the covering is comprised of an elongate envelope; the elongate envelope is comprised of a left end, a right end, a first side, a second side, a third side, and a fourth side; the valance is disposed within the elongate envelope.

13. The covering for a valance of a blind system of claim 12 further comprising indicia.

14. The covering for valances of a blind system of claim 12 wherein the first and second sides are affixed with the third and fourth sides through sewing.

15. The covering for valances of a blind system of claim 12 wherein the first side is coated with a first color and the fourth side is coated with a second color.

16. The covering for valances of a blind system of claim 12 wherein the elongate cover is comprised of a fabric.

17. The covering for valances of a blind system of claim 16 wherein the fabric is machine-washable.

18. The covering for valances of a blind system of claim 16 wherein the fabric is dry-cleanable.

19. The covering for valances of a blind system of claim 12 further comprising a zipper.

20. A covering for vanes and valances of a window treatment comprising
a covering for a vane and a covering for a valance;
the vane elongate cover sized to enclose a vane of a blind system;
the vane elongate cover comprises a first distal end, a second distal end,
a first surface, a second surface, a third surface, and a fourth surface;
the first and second surfaces are affixed to the third and fourth surfaces at a seam axis;
the elongate envelope is comprised of a left end, a right end, a first side, a second side, a third side, and a fourth side; the valance is disposed within the elongate envelope.
